(19) United States
(12) Patent Application Publication
(10) Pub. No.: US 2018/0300576 A1
(43) Pub. Date: Oct. 18, 2018

(54) SEMI-AUTOMATIC LABELLING OF DATASETS

(71) Applicants: Alexandre DALYAC, London, Greater London (GB); Razvan RANCA, London, Greater London (GB); Robert HOGAN, London, Greater London (GB); Nathaniel John MCALEESE-PARK, London, Greater London (GB); Ken CHATFIELD, Surrey (GB)

(72) Inventors: Alexandre DALYAC, London, Greater London (GB); Razvan RANCA, London, Greater London (GB); Robert HOGAN, London, Greater London (GB); Nathaniel John MCALEESE-PARK, London, Greater London (GB); Ken CHATFIELD, Surrey (GB)

(21) Appl. No.: 15/765,275

(22) PCT Filed: Oct. 3, 2016
(86) PCT No.: PCT/GB2016/053071

§ 371 Date: Apr. 2, 2018

(30) Foreign Application Priority Data
Oct. 2, 2015 (GB) 1517462.6

(51) Int. Cl. G06K 9/32; G06N 99/00; G06K 9/62; G06N 5/04; G06N 7/08

(52) U.S. Cl. CPC G06K 9/3241; G06N 99/005; G06K 9/6259; G06K 2209/23; G06N 5/046; G06N 7/08; G06K 9/6218

(57) ABSTRACT

An unlabelled or partially labelled target dataset is modelled with a machine learning model for classification (or regression). The target dataset is processed by the machine learning model; a subgroup of the target dataset is prepared for presentation to a user for labelling or label verification; label verification or user re-labelling or user labelling of the subgroup is received; and the updated target dataset is re-processed by the machine learning model. User labelling or label verification combined with modelling an unclassified or partially classified target dataset with a machine learning model aims to provide efficient labelling of an unlabelled component of the target dataset.

### FIELD

The present invention relates to classification (or regression) of data within data sets. In particular, this invention relates to assigning tags to data within one or more data sets to enhance the application of machine learning techniques to the one or more data sets. This invention also relates to a method of computer-aided quality control during data classification (or regression), as well as to a method of semi-automated tagging of data within one or more data sets.

### BACKGROUND

In the application of supervised learning algorithms for classification (or regression) or regression, initially the training data needs to be labelled correctly, i.e. requires a dependent variable to be correctly assigned to each data point of the training data. A supervised learning algorithm is a regression or classification technique where the value for a dependent variable is known and assumed to be correct. The dependent variable is the variable that is being learned, which is discrete in the classification case and continuous in the regression case, and is also known as the tag or label in classification. The values of the dependent variable for the training data may have been obtained by manual annotation from a knowledgeable human expressing his/her opinion about what the ground truth value of the dependent variable would be, or by the ground truth value itself, obtained as a recording of the ground truth outcome by other means. For example in a geology application, the training set might be a set of 3D seismic scans, a datapoint would be a voxel in a scan, the dependent variable would be an indicator for resource endowment at the point in space represented by the voxel, and this value could have been discovered by drilling or sensing. In a legal application, the training set might a set of historical litigation cases, a datapoint would be a collection of documents that represents a litigation case, the ground truth value for the dependent variable would be the actual financial outcome of the case to the defendant. The fully labelled data is then used to train one or more supervised learning algorithms.

In many examples it is necessary to produce training data by a knowledgeable human adding tags to individual data points. Preparing this training data (i.e. classifying the data correctly) can be very labour-intensive, expensive and inconvenient, especially if a large amount of training data is to be used and if the quality of the data pre-preparation is not consistently high. Conventional interactive labelling can be computationally expensive and fail to deliver good results.

In conventional image analysis for auto insurance claims triage and repair estimates, images are captured in a controlled environment under standardised conditions (such as lighting, angle, zoom, background). To provide imagery from a controlled environment, special equipment is required at dedicated sites, and cars to be assessed are transported to those dedicated sites. This can be very expensive and inconvenient.

### SUMMARY OF INVENTION

Aspects and/or embodiments can provide a method and/or system for labelling data within one or more data sets that can enable labelling of the one or more data sets with improved efficiency.

Further, aspects and/or embodiments can provide an improved system for image analysis for auto insurance claims triage and repair estimates which can alleviate at least some of the above problems. In particular the system can accommodate imagery from commodity hardware in uncontrolled environments.

According to one aspect, there is provided a method of modelling an unlabelled or partially labelled target dataset with a machine learning model for classification (or regression) comprising: processing the target dataset by the machine learning model; preparing a subgroup of the target dataset for presentation to a user for labelling or label verification; receiving label verification or user re-labelling or user labelling of the subgroup; and re-processing the updated target dataset by the machine learning model.

User labelling or label verification combined with modelling an unclassified or partially classified target dataset with a machine learning model can enable efficient labelling of an unlabelled component of the target dataset. By using a machine learning model for the modelling, images with a variety of imaging conditions (such as lighting, angle, zoom, background, occlusion) can be processed effectively. The machine learning algorithm may for example be a convolutional neural network, a support vector machine, a random forest or a neural network. Optionally the machine learning model is one that is well suited to performing classification or regression over high dimensional images (e.g. 10,000 pixels or more).

Optionally, the method may comprise determining a targeted subgroup of the target dataset for targeted presentation to a user for labelling and label verification of that targeted subgroup. This can enable a user to passively respond to queries put forward to the user, and so can lower the dependence on user initiative, skill and knowledge to improve the model and dataset quality.

Optionally, the preparing may comprise determining a plurality of representative data instances and preparing a cluster plot of only those representative data instances for presenting that cluster plot. This can reduce computational load and enable rapid preparation of a cluster plot for rapid display and hence visualisation of a high dimensional dataset. Optionally the plurality of representative data instances may be determined in feature space. Optionally the plurality of representative data instances may be determined in input space. Optionally the plurality of representative data instances may be determined by sampling. Optionally the preparing may comprise a dimensionality reduction of the plurality of representative data instances to 2 or 3 dimensions. Optionally the dimensionality reduction may be by t-distributed stochastic neighbour embedding.

Optionally, the preparing may comprise preparing a plurality of images in a grid for presenting that grid. Presentation in a grid can enable particularly efficient identification of images that are irregular.

Optionally, the preparing may comprise identifying similar data instances to one or more selected data instance by a Bayesian sets method for presenting those similar data instances. A Bayesian sets method can enable particularly efficient processing, which can reduce the time required to perform the processing.

According to another aspect, there is provided a method of producing a computational model for estimating vehicle damage repair with a convolutional neural network comprising: receiving a plurality of unlabelled vehicle images; processing the vehicle images by the convolutional neural network; preparing a subgroup of the vehicle images for presentation to a user for labelling or label verification; receiving label verification or user re-labelling or user labelling of the subgroup; and re-processing the plurality of vehicle images by the convolutional neural network.

User labelling or label verification combined with modelling target dataset that includes unlabelled images with a convolutional neural network can enable efficient classification (or regression) of unlabelled images of the target dataset. By using a convolutional neural network for the modelling, images with a variety of imaging conditions (such as lighting, angle, zoom, background, occlusion) can be processed effectively. Another machine learning algorithm may take the place of the convolutional neural network.

Optionally, the method may comprise determining a targeted subgroup of the vehicle images for targeted presentation to a user for labelling and label verification of that targeted subgroup. This can enable a user to passively respond to queries put forward to the user, and so can lower the dependence on user initiative, skill and knowledge to improve the model and dataset quality. Optionally, the preparing may comprise one or more of the steps for preparing data as described above.

Optionally, the method may further comprise: receiving a plurality of non-vehicle images with the plurality of unlabelled vehicle images; processing the non-vehicle images with the vehicle images by the convolutional neural network; preparing the non-vehicle images for presentation to a user for verification; receiving verification of the non-vehicle images; and removing the non-vehicle images to produce a plurality of unlabelled vehicle images. This can enable improvement of a dataset that includes irrelevant images.

The subgroup of vehicle images may all show a specific vehicle part. This can enable tagging of images by vehicle part. An image may have more than one vehicle part tag associated with it. The subgroup of vehicle images may all show a specific vehicle part in a damaged condition. This can enable labelling of images by damage status. The subgroup of vehicle images may all show a specific vehicle part in a damaged condition capable of repair. The subgroup of vehicle images may all show a specific vehicle part in a damaged condition suitable for replacement. This can enable labelling of images with an indication of whether repair or replacement is most appropriate.

According to another aspect, there is provided a computational model for estimating vehicle damage repair produced by a method as described above. This can enable generating a model that can model vehicle damage and the appropriate repair/replace response particularly well.

The computational model may be adapted to compute a repair cost estimate by: identifying from an image one or more damaged parts; identifying whether the damaged part is capable of repair or suitable for replacement; and calculating a repair cost estimate for the vehicle damage. This can enable quick processing of an insurance claim in relation to vehicle damage.

Optionally, to enhance usefulness, the computational model may be adapted to compute a certainty of the repair cost estimate. Optionally, to enhance usefulness, the computational model may be adapted to determine a write-off recommendation. Optionally, to enhance the quality of a repair cost estimate, the computational model may be adapted to compute its output conditional on a plurality of images of a damaged vehicle for estimating vehicle damage repair. Optionally, to enhance the quality of a repair cost estimate, the computational model may be adapted to receive a plurality of images of a damaged vehicle for estimating vehicle damage repair. Optionally, to enhance usefulness, the computational model may be adapted to compute an estimate for internal damage. Optionally, to enhance usefulness, the computational model may be adapted to request one or more further images from a user.

According to another aspect, there is provided software adapted to produce a computational model as described above. According to another aspect, there is provided a processor adapted to produce a computational model as described above.

Aspects and/or embodiments can extend to a method of modelling data substantially as herein described and/or as illustrated with reference to the accompanying figures.

Aspects and/or embodiments can also extend to a method of producing a computational model for estimating vehicle damage repair substantially as herein described and/or as illustrated with reference to the accompanying figures.

Aspects and/or embodiments can also extend to a computational model substantially as herein described and/or as illustrated with reference to the accompanying figures.

Aspects and/or embodiments can also extend to software for modelling data substantially as herein described and/or as illustrated with reference to the accompanying figures.

Aspects and/or embodiments can also extend to a system for modelling data substantially as herein described and/or as illustrated with reference to the accompanying figures.

Aspects and/or embodiments can also extend to methods and/or apparatus substantially as herein described with reference to the accompanying drawings.

Aspects and/or embodiments can also provide a computer program and a computer program product for carrying out any of the methods described herein and/or for embodying any of the apparatus features described herein, and a computer readable medium having stored thereon a program for carrying out any of the methods described herein and/or for embodying any of the apparatus features described herein.

Aspects and/or embodiments can also provide a signal embodying a computer program for carrying out any of the methods described herein and/or for embodying any of the apparatus features described herein, a method of transmitting such a signal, and a computer product having an operating system which supports a computer program for carrying out any of the methods described herein and/or for embodying any of the apparatus features described herein.

Any apparatus feature as described herein may also be provided as a method feature, and vice versa. As used herein, means plus function features may be expressed alternatively in terms of their corresponding structure, such as a suitably programmed processor and associated memory.

Any feature in one aspect may be applied to other aspects, in any appropriate combination. In particular, method aspects may be applied to apparatus aspects, and vice versa. Furthermore, any, some and/or all features in one aspect can be applied to any, some and/or all features in any other aspect, in any appropriate combination.

It should also be appreciated that particular combinations of the various features described and defined in any aspects can be implemented and/or supplied and/or used independently.

Furthermore, features implemented in hardware may generally be implemented in software, and vice versa. Any reference to software and hardware features herein should be construed accordingly.

### BRIEF DESCRIPTION OF THE DRAWINGS

These and other aspects of the present invention will become apparent from the following exemplary embodiments that are described with reference to the following figures having like-reference numerals in which:

FIG. 1 is a schematic of a method of labelling data;

FIG. 2 is a schematic of a step of the method of FIG. 1;

FIG. 3 is a schematic of a system for labelling data;

FIGS. 4a and 4b are views of a graphic user interface with a cluster plot;

FIG. 5 is a view of a graphic user interface with a grid of images;

FIGS. 6a and 6b are views of a graphic user interface for targeted supervision; and

FIG. 7 is a schematic of a system for vehicle damage estimation.

### SPECIFIC DESCRIPTION

For approximately a decade, vehicle body shops and loss adjustors in numerous countries have been capturing photos of damaged vehicles as evidence to back repair estimates submitted to insurers or solicitors. With approximately 19 million motor claims in the US alone per year, and approximately 10 images per claim, a large body of imagery data for damaged vehicles exists.

Machine learning is an attractive tool for taking advantage of the existing vehicle damage imagery, and deep learning (and in particular convolutional neural networks) has made huge strides towards the automated recognition and understanding of high-dimensional sensory data. One of the fundamental ideas underpinning these techniques is that the algorithm can determine how to best represent the data by learning to extract the most useful features. If the extracted features are good enough (discriminative enough), then any basic machine learning algorithm can be applied to them to obtain excellent results. Convolutional neural networks (also referred to as convnets or CNNs) are particularly well suited to categorise imagery data, and graphic processor unit (GPU) implementations of convolutional neural networks trained by supervised learning have demonstrated high image classification (or regression) performance on ‘natural’ imagery (taken under non-standardised conditions and having variability in e.g. lighting, angle, zoom, background, occlusion and design across car models, including errors and irrelevant images, having variability regarding quality and reliability).

To take advantage of the large body of vehicle damage imagery for training a convolutional neural network the data needs to be as error-free as possible, and in particular images need to be labelled correctly. Industrial datasets pose novel problems to deep learning, such as dealing with noisy/missing/inconsistently or partially labelled data which may also include irrelevant data.

In order for the machine learning to perform good quality classification (or regression) it is necessary to ensure good data quality for training, and to train a sufficiently good model on the data. Conventionally a user is required to first prepare data for training by going through the data and (re-)labelling the data until satisfied with the quality. Then a model is trained on the cleaned data.

Labelling (and more generally cleaning) the training data set by virtue of a user assigning labels to an image is a very lengthy and expensive procedure to the extent of being prohibitive for commercial applications. Significantly improved efficiency can be achieved if the preparation of the training data set and the training of the model are interleaved. This is not an intuitive approach as the algorithm starts learning with a dataset that is known to be deficient. It can however be very efficient as it takes advantage of the ability of machine learning algorithms to identify datasets that are dissimilar and potentially erroneous. Each iteration of model training informs the best approach for the subsequent relabelling iteration (and vice versa). The end result of this iterative process is a dataset of sufficient quality and a model providing sufficiently discriminative features on this dataset.

The data may can be in the form of images (with each image representing an individual dataset), or it can be any high-dimensional data such as text (with each word for example representing an individual dataset) or sound.

In order to enable use of existing imagery data for training a convolutional neural network semi-automatic labelling is now described.

Semi-automatic labelling semi-automates the labelling of datasets. A model is trained on data that is known to include errors. The model attempts to model and classify (or regress) the data. The classification, also referred to as the labelling or the tagging, of selected data points (individual images or groups of images) are reviewed by a user (also referred to as an oracle or a supervisor) and corrected or confirmed. Labels are iteratively refined and then the model is refined based on the labelled data. The user can proactively review the model output and search for image for review and labelling, or the user can passively respond to queries from the model regarding labelling of particular images.

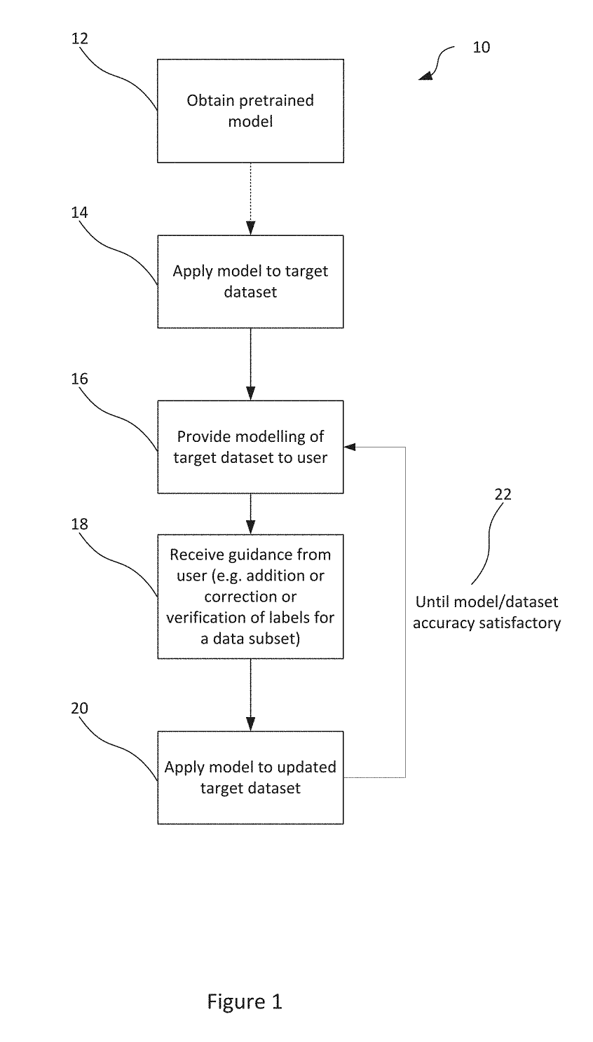

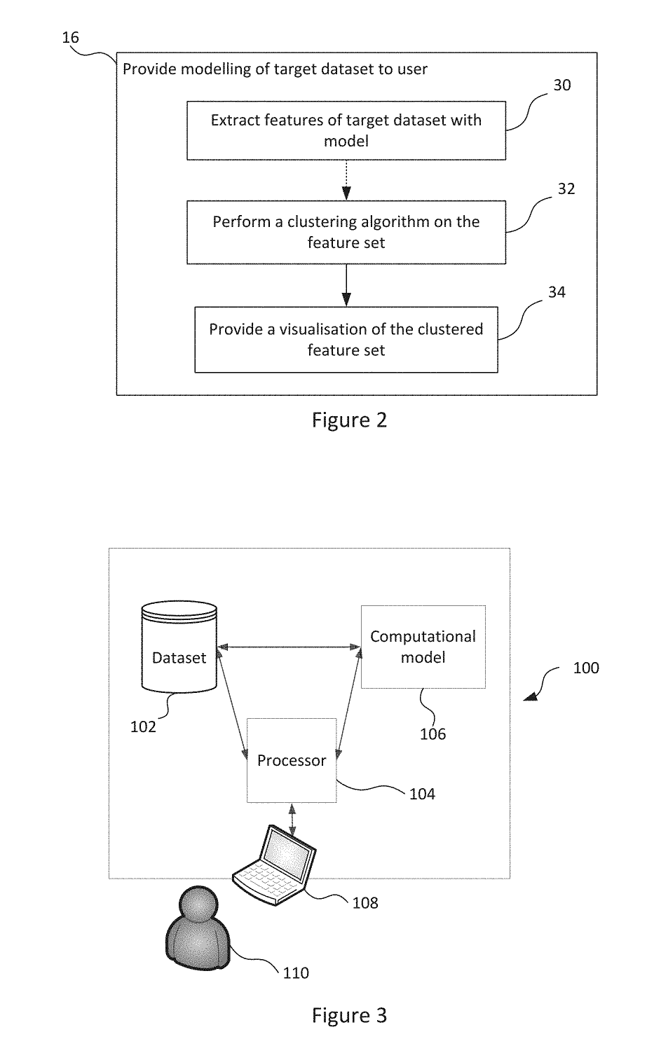

FIG. 1 is a schematic of a method of semi-automatic labelling. FIG. 2 is a schematic of a step of the method of semi-automatic labelling of FIG. 1.

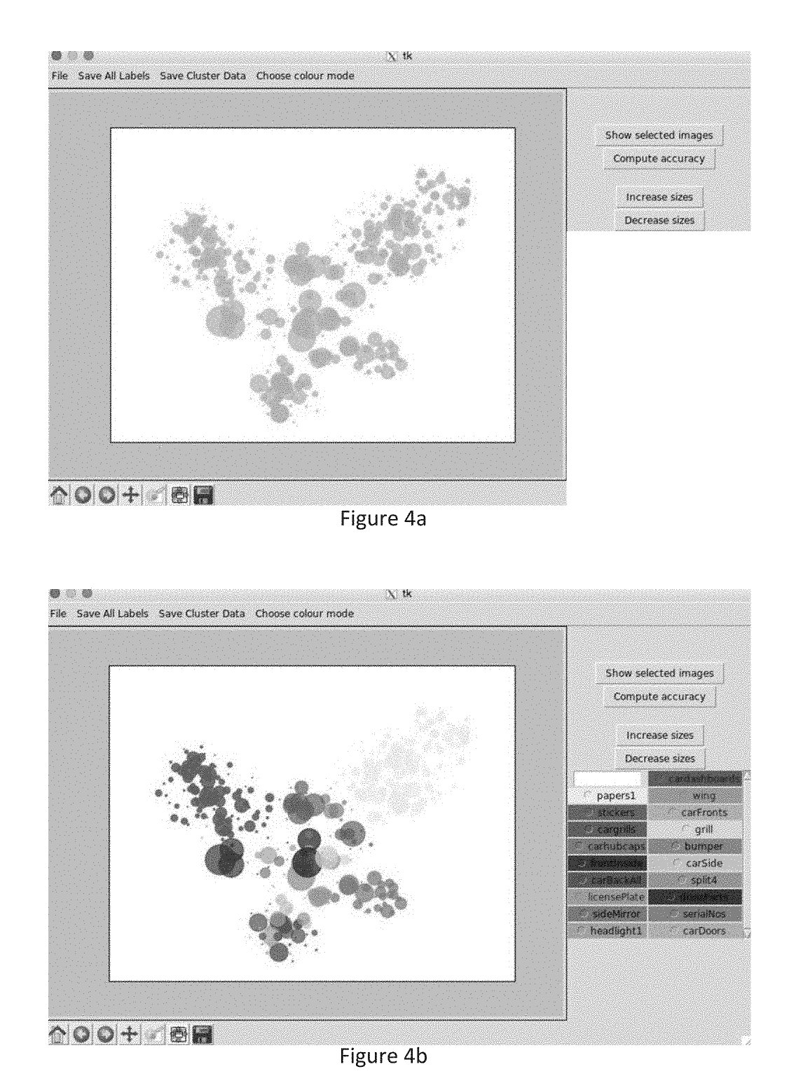

FIG. 3 is a schematic of a system 100 for semi-automatic labelling. A processor 104 provides to a user 110 via an input/output 108 information regarding how a dataset 102 is modelled with a computational model 106. The user 110 provides guidance via the input/output 108 to the processor 104 for modelling the dataset 102 with the computational model 106.

A sequence of operations for semi-automatic labelling with proactive user review is:
1. Pre-train a model on the best possible (regarding volume and labels) similar data;
2. Model the target data with the pre-trained model;
3. Prepare the modelled target data for the user for review:
   a. extract features of the target dataset with the model (referred to as the feature set);
   b. perform dimensionality reduction on the feature set;
   c. assign labels to no/some/all feature points;
   d. apply a visualisation technique to the labelled feature set;
4. Present an efficient interface to the user for browsing and editing the tagged feature set:
   a. The user browses efficiently through the labelled feature set to find regions to validate;
   b. The user validates or corrects labels seen on the interface;
5. Repeat cycle from Step 2 with validated/corrected labelling until sufficient data and model quality is achieved.
6. Fine tune latest feature extraction model, using some/all of labelled dataset or feature set, until sufficient data and model quality is achieved.

In an example of a semi-automatic labelling procedure as set out above approximately 30,000 images can be labelled in an hour with a single user into a scheme with 18 classes with 90% accuracy.

In the case of passive user response to queries (also referred to as targeted supervision), Steps 3 and 4 of the sequence described above are as follows:
3. Prepare the modelled full data for the user for review:
   a. extract features of a target dataset with model (referred to as the feature set);
   b. perform dimensionality reduction on feature set;
   c. assign labels to no/some/all feature points;
   d. apply a visualisation technique to the labelled feature set;
   e. approximate a best next user query;
4. Present a query to the user for reviewing the labelled feature set:
   a. efficiently present query to user;
   b. The user validates or corrects labels seen on the interface;

Passive and proactive user review can also be combined by providing both alongside one another.

Step 3c ‘assign labels to some/all feature points’ can be performed for classification by a clustering technique such as partitioning the feature space into class regions. Step 3c can also be performed for regression by a discretising technique such as defining discrete random values over the feature space.

As part of Step 6 (fine tuning) following additional steps may be executed:
a. Run the model on unseen data and rank the images by classification (or regression) probability (possible because binary); and
b. Present high probability images and low probability images to the user for identification of particularly informative mistakes.
   In a variant, semantic clustering (where data is shown separated by image content, such that for example all car bumper images are shown together) in a cluster plot is enhanced with probability ranking (for example with colour representing a probability) to enable more powerful fine tuning.

There are a number of further considerations to take into account in implementing the sequence set out above, including:
Making the best use of any existing labels to initialize the process. In the worst case the labels are useless and an unsupervised initialization is performed. Otherwise a supervised model can be trained on whatever labels are available.
Optimising the visualisation of the extracted features so that the user can understand what the model is doing. The actual features exist in a high-dimensional space (i.e. >1000 dimensions) and so they will need to be reduced to 2 or 3 dimensions while maintaining as much information as possible. Performing this visualisation in real-time brings a large benefit.
Relabelling a portion of data so as to bring the most benefit to the next training iteration. One approach is for the model to give the user a ranked list of images/image clusters that it found “most confusing” during its training.
Optimising the re-training of the model to take account of the new user input. In the simplest case the user specifies the extent to which he believes the model should be retrained. This affects how expressive the retraining is and how long it takes. Sufficient expressiveness is required to take advantage of the new information given to the model, but not so much as to over-fit the new data.
Evaluating the real performance of the model on each iteration. Normally a portion of the data is not used for training so that the performance of the model can be evaluated on that portion. However not using a part of small amount of recently relabelled data for training may significantly slow down the speed of the relabelling cycle. A balance must be struck between the two.

Some techniques that can be used to implement the semi-automatic labelling described above are:
Pre-trained convolutional neural network
extract features by parallelising across GPUs
principal component analysis (PCA) for dimensionality reduction. This is particularly suitable for t-distributed stochastic neighbour embedding (tSNE) For Bayesian sets PCA may be less suitable. Dimensionality reduction may even be unnecessary if tSNE is fast enough.
feature set exploration for seeding centroids with a k-means clustering algorithm
t-distributed stochastic neighbour embedding (tSNE) on k-means centroids
graphic user interface (GUI) with a cluster plot of tSNE with clusters represented as circles with centroid as centre, number of images represented by diameter, most common class colour as colour
GUI grid of ˜100 images to validate/edit labels
Bayesian sets applied to convolutional neural networks
softmax finetuning of model
siamese finetuning of model
triplet loss finetuning of model

A pre-trained convolutional neural network may for example be trained on images from the ImageNet collection.

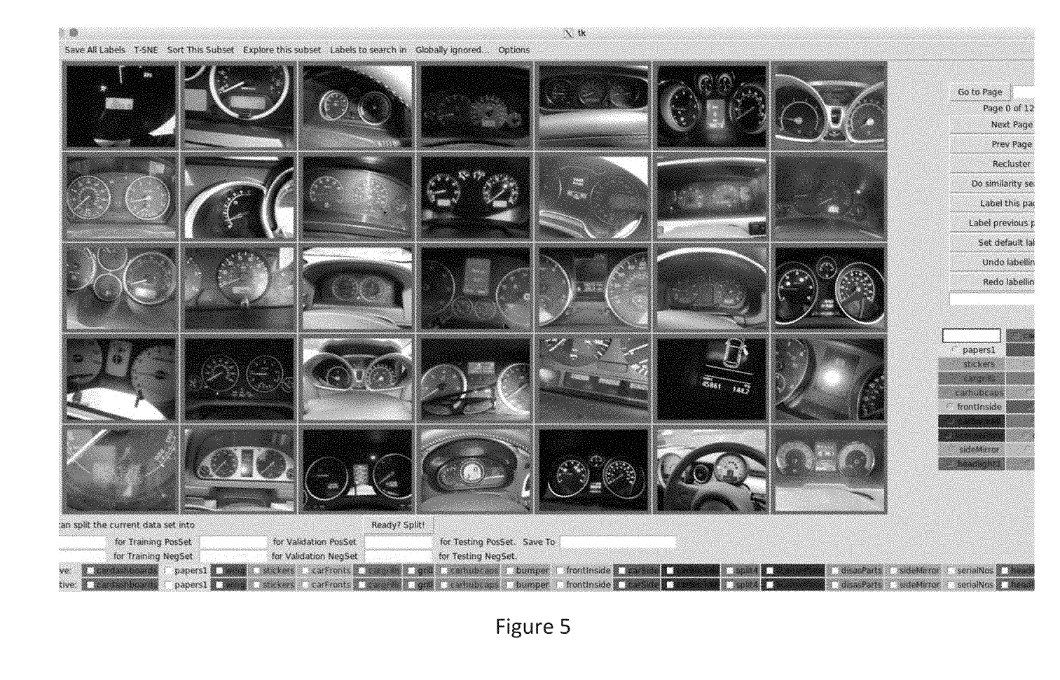

FIG. 4a is a view of a graphic user interface with a cluster plot that provides semantic clustering (such that for example all car bumper images are in the same area in the cluster plot). The cluster plot shows circles indicating the distribution of the data set in feature space. The plot is presented to a user who can then select one or more of the circles for further review. Labelled/unlabelled status can be indicated in the plot, for example by colour of the circles. Selected/not selected for review can be indicated in the plot, for example by colour of the circles. FIG. 4b is a view of a graphic user interface with a cluster plot where the colour of circles indicates the label associated with that data. The user may be presented with image data when the user hovers over a circle. User selection of a group of circles can be achieved by allowing the user to draw a perimeter around a group of interest in the cluster plot.

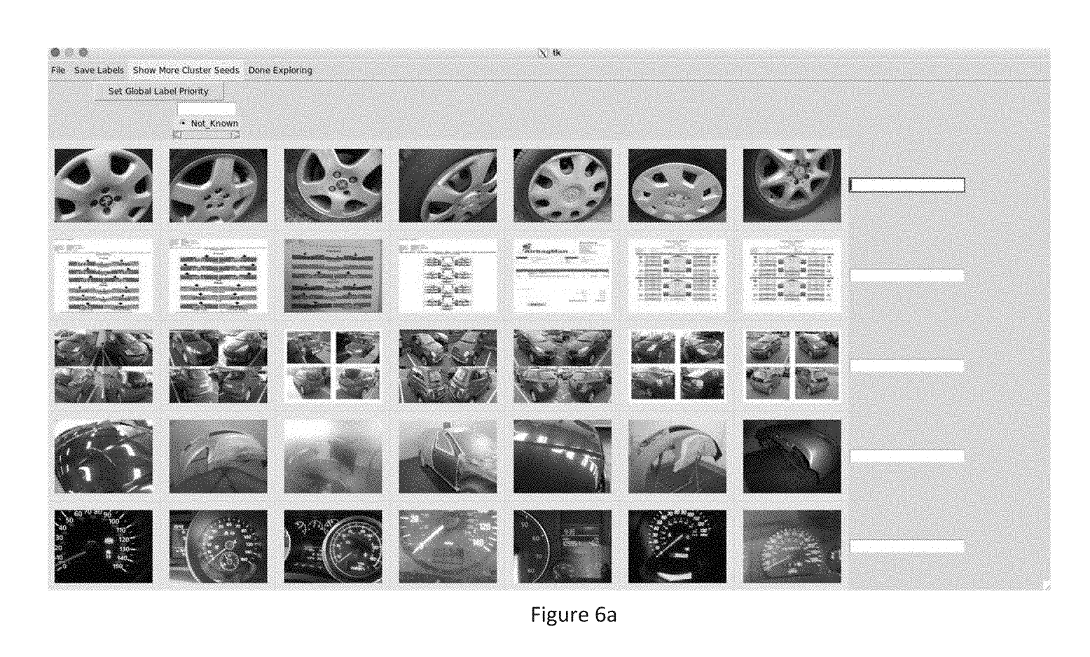

FIG. 5 is a view of a graphic user interface with a grid of images. Images that are selected in a cluster plot are shown in a grid for user review. The grid is for example with 8 images side by side in a line, and 6 lines of images below each other. In the illustrated example the grid shows 7×5 images. The human visual cortex can digest and identify dissimilar images in a grid format with particularly high efficiency. By displaying images in the grid format a large number of images can be presented to the user and reviewed by the user in a short time. If for example 48 images are included per view then in 21 views the user can review over 1000 images. Images in the grid can be selected or deselected for labelling with a particular label. Images can be selected or deselected for further review, such as a similarity search.

A similarity search may be executed in order to find images that are similar to a particular image or group of images of interest. This can enable a user to find an individual image of particular interest (for example an image of a windscreen with a chip in a cluster of windscreen images), find further images that are similar, and to provide a label to the images collectively.

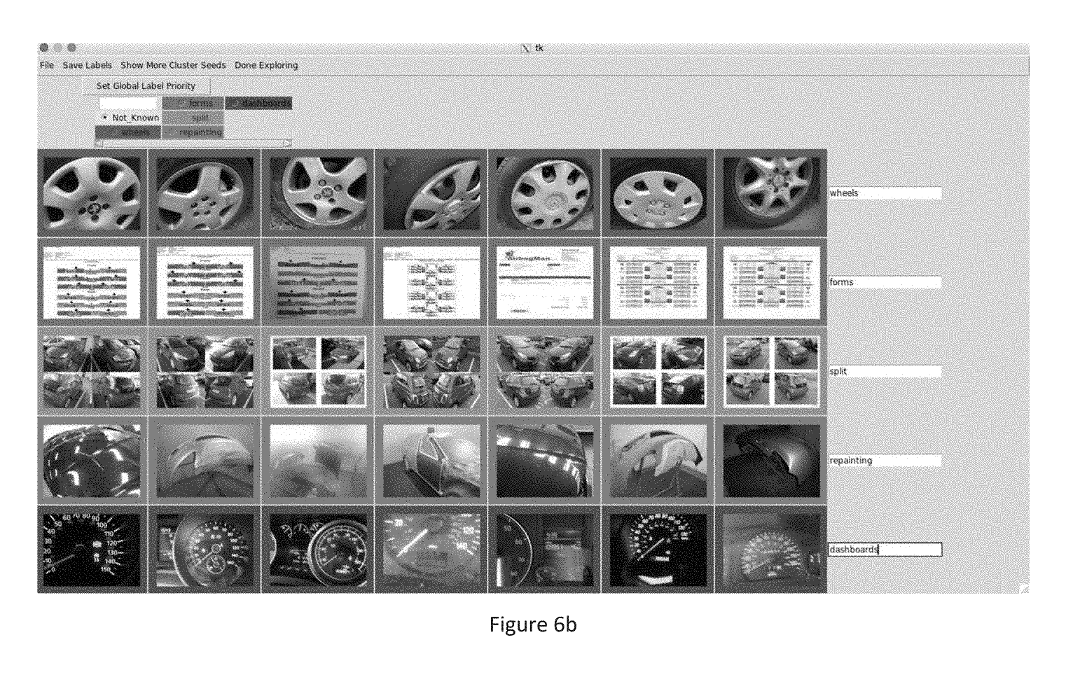

FIGS. 6a and 6b are views of a graphic user interface for targeted supervision. Here a number of images (in the illustrated example 7 images) that appear to be clustered are provided to the user and a field for user input of a label for those images is provided. FIG. 6a shows the fields for user input empty, and FIG. 6b shows the fields with a label entered by the user, and the images marked with a coloured frame where the colour indicates the label associated with that image.

Now a method of performing dimensionality reduction on the feature set (Step 3.c above) is described in more detail. In an example the feature set is a 4096-dimensional vector (and more generally an N-dimensional vector) having values in the range of approximately −2 to 2 (and more generally in a typical range). Dimension reduction to two or three dimensions (as can be intuitively understood by a human) can require considerable computational resources and take significant time. In order to shorten this computationally labour-intensive step, the data set is clustered in feature space and from each cluster a single representative data instance (also referred to as a centroid; a k-means cluster centroid for example) is selected for further processing. The dimension reduction is then performed on the representative data only, thereby reducing the computational load to such an extent that very rapid visualisation of very large data sets is possible. Data-points from the dataset are not individually shown in the cluster plot to the user, however the diameter of a circle in the cluster plot shown to the user indicates the number of data-points that are near the relevant representative data instance in feature-space, and hence presumed to have identical or similar label values. By selection of a circle in the cluster plot the user is presented with all of the images represented by that circle. This allows a user to check all the images represented by the representative. The scaling of the circles can be optimised and/or adjusted by a user for clarity of the display.

Now a method of performing a similarity search is described in more detail. The images are represented in feature-space by high-dimensional vectors (such as 4096-dimensional vectors), having a range of values (such as approximately from −2 to 2). Performing a similarity search on a large number of such vectors can be computationally labour-intensive and take significant time. Bayesian sets can provide a very quick and simple means of identifying similar entities to an image or group of images of particular interest. In order to apply a Bayesian set method the data (here the high-dimensional vectors) is required to be binary rather than having a range of values. In order to apply a Bayesian set method the feature set vectors are converted into binary vectors: values that are near-zero are changed to zero, and the values that are farther away from zero are changed to one. For similarity searching by the Bayesian set method this can produce good results. The application of Bayesian sets to convolutional neural networks (or more generally machine learning models suitable for images and with sparse representations) is particularly favourable as convolutional neural networks typically produce feature sets with sparse representations (lots of zeros in the vector) which are consequently straightforward to cast to binary vectors with sparse representations in the context of semi auto labelling.

Now semi-automatic labelling applied to vehicle damage estimation is described in more detail. For a given instance of vehicle damage the outcome is a prediction of the repairs that are necessary and an estimate of the corresponding repair cost based on natural images of the damaged vehicle. This can enable an insurer for example to make a decision as to how to proceed in response to the vehicle damage. The outcome may include a triage recommendation such as ‘write the vehicle off’, ‘significant repairs necessary’, or ‘light repairs necessary”.

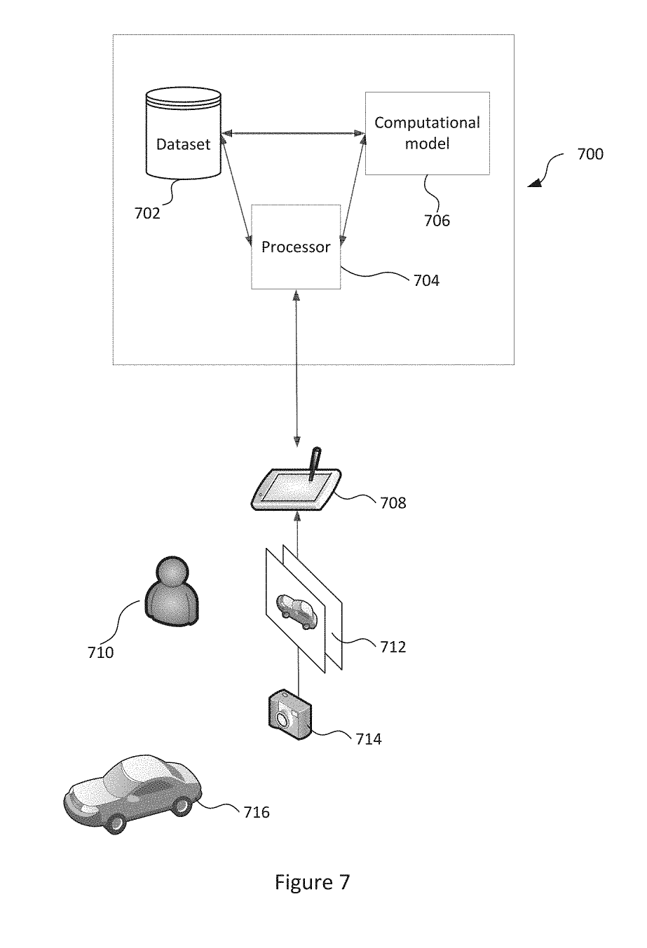

FIG. 7 is a schematic of a system 700 for vehicle damage estimation. A user 710 captures images 712 of a damaged vehicle 716 with a camera 714 and transmits the images 712 via a mobile device 708 (e.g. a tablet or smartphone) to the system 700. A processor 704 uses a computational model 706 to evaluate the images 712 and produce a vehicle damage estimate, which is provided back to the user 710 via the mobile device 708. A report may be provided to other involved parties, such as an insurer or a vehicle repair shop. The images 712 may be captured directly by the mobile device 708. The images 712 may be added to the dataset 702 and the model 706 may be updated with the images 712.

In order to produce a repair estimate, the procedure is broken down as follows for optimal processing:
1. Recognise a set of damaged parts via deep learning (preferably a convolutional neural network). For an image provided from a vehicle owner for example no part labels are provided, so a fairly robust model for the image data is necessary. It may be required that the vehicle owner provides an image with the whole vehicle visible. Real-time interactive feedback to a user may be implemented in order to ensure that the most appropriate and suitable images are provided. For example, feeding images in through one or more “quality assurance” classifiers, and returning the results in real time, would ensure that the user captures all necessary images for accurate repair estimating.
2. Predict a ‘repair’/‘replace’ label for each damaged part via a convolutional neural network. The repair/replace distinction is typically very noisy and mislabelling may occur. To address this part labels per image are identified. Thereafter the repair/replace labels are not per image, but per part, and so more reliable. Cross referencing can assist in obtaining repair/replace labels for individual images where a corresponding part is present. In order to eliminate the need for close up images the relevant crops of images where the whole vehicle is present may be prepared. Real-time interactive feedback to a user may be implemented in order to obtain specific close up images for parts where otherwise the confidence is low. Step 2 may be combined with the preceding Step 1 by predicting a ‘not visible’/‘undamaged’/‘repair’/‘replace’ label for each part.
2.5. Predict an ‘undamaged’/‘repair’/‘replace’ label for relevant internal parts, via a convolutional neural network and predictive analytics. Predicting internal damage accurately is difficult, and even human expert assessors may struggle. In order to enable good results telematics data may be provided from the vehicle in order to determine which internal electronic parts are dead/alive, and for appending to the predictive analytics regression (eg accelerometer data).
3. Obtain labour times for performing each labour operation, for example via a prediction or by taking averages. This step may also involve a convolutional neural network. It may be preferable to predict damage severity instead of labour hours per se. Labour time data may be obtained from third party. In case an average time is used an adjustment to the average time may be made in dependence on one or more easily observable parameter such as vehicle model type, set of all damaged parts, damage severity.
4. Obtain part prices & labour rates for each part to replace. The prices and rates may be obtained via lookup or by taking average values. For looking up prices and rates an API call may be made to for example an insurer, a third party or to a database of associated repair shops. Average values may be obtained via lookup. In case an average price or rate is used an adjustment to that average price or rate may be made in dependence on one or more observable or obtainable parameter such as model type, set of all damaged parts, damage severity, fault/non fault.
5. Compute repair estimate, by adding and multiplying prices, rates, times. In order to obtain a posterior distribution of the repair estimate the uncertainty of the repair estimate may also be modelled. For example, a 95% confidence interval of a total repair cost may be provided, or a probability of the vehicle being a write off. The claim may be passed on to a human if the confidence for the repair estimate is insufficient.

By this procedure a repair estimate can be produced at first notice of loss, from images captured by a policyholder for example with a smartphone. This can enable settling of a claim almost immediately after incurrence of damage to a vehicle. It can also enable rapid selection, for example via mobile app, of:
a new vehicle if the damaged vehicle is a total loss;
a courtesy vehicle if significant repairs are necessary;
a repair shop with favourable capacity and prices if significant repairs are necessary;
replacements parts for early sourcing from a favourable supplier if significant repairs are necessary; or
on-site repair if only light damage is incurred (e.g. windscreen chip repair).

Images can be supplied for a repair estimate at a time point later than the first notice of loss, for example after official services such as police or first aiders have departed or at a vehicle body shop or other specialised centre. An output posterior distribution of the repair estimate can be produced to provide more insight e.g. 95% confidence interval for a repair estimate; or a probability of write off. The repair estimate process can be dual machine/human generated, for example by passing the estimation over to a human operator if the estimate given by the model only has low confidence or in delicate cases. Parties other than the policyholder can capture images (e.g. a co-passenger in the damaged vehicle, another person involved in the accident, police, ambulance/first aid staff, loss adjustor/assessor, insurer representative, broker, solicitor, repair workshop personnel). The image(s) provided for the repair estimate may be from a camera or other photographic device. Other related information can be provided to the policyholder such as an excess value and/or an expected premium increase to dis-incentivise claiming.

By implementing repair estimation as described here both an insurer and a policyholder can enjoy a number of benefits. For example, an insurer can:
decrease administration costs for managing a claim;
decrease the claim ratio (the loss ratio) by providing an exact or at least a good approximation of an appropriate premium increase;
decrease claim amounts by settling fast and decreasing the chance of a high injury claim;
(for certain countries) decrease claim amounts for non-fault claims by routing the policyholder directly to a well-controlled repair chain;
decrease key-to-key time;
increase customer retention; and
incentivise potential customers to switch insurer.

The policyholder can enjoy superior customer service and take advantage of suppliers bidding for custom. Certain part suppliers can benefit from preferred supplier status. Vehicle repairers and bodyshops can avoid spending time preparing estimates.

In the steps described above a convolutional neural network is employed. A multi-instance learning (MIL) convolutional neural network that can accommodate multi-image queries may perform substantially better than a convolutional neural network for single-image queries. Multiple images can in particular help to remove imagery noise from angle, lighting, occlusion, lack of context, insufficient resolution etc. In the classification case, this distinguishes itself from traditional image classification, where a class is output conditional on a single image. In the context of collision repair estimating, it may often be impossible to capture, in a single image, all the information required to output a repair estimate component. In an example the fact that a rear bumper requires repair can only be recognised by capturing a close-up image of the damage, which loses the contextual information that is required to ascertain that a part of the rear bumper is being photographed. By training a machine learning model that uses the information in multiple images in the example the machine learning model can output that the rear bumper is in need of repair. In a convolutional neural network architecture that can accommodate multi-image queries a layer is provided in the convolutional neural network that pools across images. Maximum pooling, average pooing, intermediate pooling or learned pooling can be applied. Single image convolutional neural networks may be employed for greater simplicity.

Now a procedure for producing a model that can accomplish Steps 1 and 2 of producing a repair estimate as describe above—recognising a set of damaged parts and predicting a ‘repair’/‘replace’ label—is described in more detail. This is achieved essentially by solving labelling problems with semi-automatic labelling as described above. This procedure is applied to a dataset that includes unlabelled vehicle images for every vehicle part that is to be recognised/diagnosed.
A. remove irrelevant images. By removing irrelevant data the data becomes more easily presentable.
   1. Extract features of the target dataset with a pretrained model (as described in more detail above);
   2. Present to the user how the data is modelled (GUI plot of tSNE as described above). This permits the user to identify irrelevant clusters easily as they are semantically distinct.
   3. Receive a user selection (or confirmation) of irrelevant clusters and remove the corresponding images from the dataset; and
   4. Repeat until no further irrelevant images are to be removed anymore.
B. create ‘part not visible’, ‘part is undamaged’, ‘part is damaged’ classifier
   1. Extract features of the target dataset with the model and target data as produced in Step A above;
   2. Present to the user how the data is modelled (GUI plot of tSNE as described above). This permits the user to identify highly skewed clusters and label them as appropriate.
      If a region of feature space is not explored: present to the user how a subset of data is modelled that the user has not inspected yet. The user may seek such information, or an active learning algorithm can be used to identify and provide regions for review to the user.
      For unskewed clusters: present images to the user for browsing and labelling with similarity searches:
         similarity searches can provide quick identification of images having a common label;
         the user has prior knowledge of the class hierarchy with subclasses (and potentially also density) to ensure the model correctly represents real life vehicle damage possibilities (e.g. if a certain type of repairable front left fender damage can occur in real life, then the model needs to be able to identify such cases);
         high user supervision may be required if the identified features do not disentangle the class hierarchy suitably;
         if the user does not have an established class hierarchy available then the user can build subclasses ad hoc by browsing and learning from the dataset; and
         the distribution is generated cluster by cluster, page by page. When salient cases are reached the user can dwell longer on those cases and explore them via similarity searches.
   3. Receive a user labelling (or label validation) and update the dataset;
   4. Train the model; if the part classification (or regression) is not satisfactory, repeat cycle from Step 2 with validated/corrected labelling until sufficient data and model quality is achieved;
   5. Once features cease to be discriminative (e.g. less variance in the contents of a cluster can be found, and label editing becomes a matter of more subtle visual patterns) fine tune. Fine tuning can also be interleaved or combined with the preceding cycle, rather than undertaking the cycles in sequence.
   6. Extract features of the target dataset;
   7. Present to the user how the data is modelled. Images can be presented ranked by classification (or regression) output, so that the user can browse via classification (or regression) output to understand which subclasses the model distinguished correctly, and which ones are recognised only poorly. The user can focus the next step of learning in dependence on which subclasses are only poorly recognised, via a similarity search. A suggested next learning step can be provided to the user by virtue of an active learning technique that can automate browsing and identification of poorly recognised subclasses.
   8. Receive guidance from the user and update the dataset accordingly; and
   9. Train the model; if the model accuracy is not satisfactory, repeat cycle from Step 6 with validated/corrected labelling until sufficient data and model quality is achieved.
C. Create ‘repair part’, ‘replace part’ classifier (the target dataset can include partially mislabelled images)
   1. Extract repair/replace metadata from csv/txt files that associate a particular damaged part image with an appropriate action;
   2. Allocate repair/replace to ‘part damaged’ labelled parts;
   3. Train the model with the updated target dataset and extract features of the dataset;
   4. Present to the user how the data is modelled (GUI plot of tSNE as described above). This permits the user to identify highly skewed clusters and label them as appropriate.
      For unskewed clusters: present images to the user for browsing and labelling with similarity searches, as described in more detail in Step B.4 above.
      5. Receive a user labelling (or label validation) and update the dataset;
      6. Train the model; if the part classification (or regression) is not satisfactory, repeat cycle from Step 4 with validated/corrected labelling until model accuracy is satisfactory.
D. Combine labelled data from Steps B and C to train a single 4 class classifier ('part not visible', ‘part undamaged’, ‘repair part’ and ‘replace part’).
E. Measure the true accuracy of the trained model. An unbiased test dataset is required for this. The preferred technique for obtaining a test dataset is taking a random sample from the full dataset, and then having a user browse through all images of the test dataset and assign all labels correctly. Some assistance may be obtained from semi-automatic labelling, but the correct labelling of every image of the test dataset must be verified by the user.

Now an adaptation for internal damage prediction is described in more detail. Internal damage prediction can be implemented for example with predictive analytics such as regression models. Images of a damaged vehicle do not permit direct observation of internal parts.
A. Predict repair estimate: regress repair cost
   1. Determine an indication of the predictive ability of an image: regress total cost of repair, gradually reducing what to regress on. Ways in which regressors that would be expensive to measure in practice could be approximated and removed by:
      recording and considering the status of just a few parts, it may be possible to generate an accurate estimate of the total cost. The number of parts that can be omitted from the regression model is analysed.
      potentially recording and considering images of internal parts of the vehicle (for example by opening the bonnet), and even to remove certain parts to view specific internal parts. It may be sufficient to record and consider only images of the exterior of the vehicle. The number of internal parts that can be omitted from the regression model is analysed.
      considering the extent of damage of a part in order to determine a labour operation (repair, replace, do nothing). The output of a repair/replace classifier (trained on semi-automatically labelled data as described above) could feed into this.
      considering part pricings: e.g. exact original equipment part price, current/historical average price, Thatcham price
      considering whether it is a fault/non-fault claim
      evaluating total labour cost: consult e.g. an exact labour rate, average labour rate or fault/non-fault labour rate, and also consult e.g. an exact labour time, average labour time, or Thatcham labour time for each labour operation
      considering other metadata such as car type, mileage
      evaluating the sensitivity of the prediction (x % classification error =>y % cost prediction error)
      considering whether a typically expected error (e.g. 6%) can be predicted by a metadata field such as type of damage, company making the estimate
      considering a rule-based sequence of labour obtainable from a lookup
   2. Evaluate the predictive ability of an image
      take top regression models from above and substitute certain ground truth values with convolutional neural network results: substitute ‘repair’/'replace' labels for visible parts with equivalent predictions from the convolutional neural network model. In this way classification outputs feed into regressions. The regression parameters may be fine-tuned to the convolutional neural network outputs. The number of considered parts decreases as the number of parts that can be omitted from the regression model is analysed.
      train the convolutional neural network to perform regression so as to regress directly on images. The total cost is regressed on the images and all other observables. The error of the predicted repair cost is propagated back.
B. Predict total loss: regress write off. The steps performed for Step A above (regress repair cost) are adapted for regressing a binary indicator indicating whether to write off a damaged vehicle instead of repairing it for a repair cost.
   In the process described above the sequence of the steps can be varied. More information is available in an image of a damaged part than in a binary repair/replace decision. Hence by regressing the repair costs to images the accuracy can be improved as compared to an image-less model.
   An implementation of the repair estimate may include further features such as:
   features to deter and detect imagery fraud and other fraud;
   features to determine who is at fault; and/or
   features to capture and analyse images of other cars and/or property involved in a collision for an insurer to process.

It will be understood that the present invention has been described above purely by way of example, and modifications of detail can be made within the scope of the invention.

Each feature disclosed in the description, and (where appropriate) the claims and drawings may be provided independently or in any appropriate combination.

Reference numerals appearing in the claims are by way of illustration only and shall have no limiting effect on the scope of the claims.

What is claimed is:

1. A method of modelling an unlabelled or partially labelled target dataset with a machine learning model for classification or regression comprising:
processing the target dataset by the machine learning model;
preparing a subgroup of the target dataset for presentation to a user for labelling or label verification;
receiving label verification or user re-labelling or user labelling of the subgroup; and
re-processing the updated target dataset by the machine learning model.

2. A method according to claim 1, wherein the machine learning algorithm is a convolutional neural network, a support vector machine, a random forest or a neural network.

3. A method according to claim 1 or 2, further comprising determining a targeted subgroup of the target dataset for targeted presentation to a user for labelling and label verification of that targeted subgroup.

4. A method according to any of claims 1 to 3, wherein the preparing comprises determining a plurality of representative data instances and preparing a cluster plot of only those representative data instances for presenting that cluster plot.

5. A method according to claim 4, wherein the plurality of representative data instances is determined in feature space.

6. A method according to claim 4, wherein the plurality of representative data instances is determined in input space.

7. A method according to any of claims 4 to 6, wherein the plurality of representative data instances is determined by sampling.

8. A method according to any of claims 4 to 7, wherein the preparing comprises a dimensionality reduction of the plurality of representative data instances to 2 or 3 dimensions.

9. A method according to claim 8, wherein the dimensionality reduction is by t-distributed stochastic neighbour embedding.

10. A method according to any of claims 1 to 9, wherein the preparing comprises preparing a plurality of images in a grid for presenting that grid.

11. A method according to any of claims 1 to 10, wherein the preparing comprises identifying similar data instances to one or more selected data instance by a Bayesian sets method for presenting those similar data instances.

12. A method of producing a computational model for estimating vehicle damage repair with a machine learning model comprising:
receiving a plurality of unlabelled vehicle images;
processing the vehicle images by the machine learning model;
preparing a subgroup of the vehicle images for presentation to a user for labelling or label verification;
receiving label verification or user re-labelling or user labelling of the subgroup; and
re-processing the plurality of vehicle images by the machine learning model.

13. A method according to claim 12, further comprising determining a targeted subgroup of the vehicle images for targeted presentation to a user for labelling and label verification of that targeted subgroup.

14. A method according to claim 12 or 13, wherein the preparing comprises any of the steps according to any of claims 4 to 11.

15. A method according to any of claims 12 to 14, further comprising:
receiving a plurality of non-vehicle images with the plurality of unlabelled vehicle images;
processing the non-vehicle images with the vehicle images by the machine learning model;
preparing the non-vehicle images for presentation to a user for verification;
receiving verification of the non-vehicle images; and
removing the non-vehicle images to produce a plurality of unlabelled vehicle images.

16. A method according to any of claims 12 to 15, wherein the subgroup of vehicle images all show a specific vehicle part.

17. A method according to any of claims 12 to 16, wherein the subgroup of vehicle images all show a specific vehicle part in a damaged condition.

18. A method according to any of claims 12 to 17, wherein the subgroup of vehicle images all show a specific vehicle part in a damaged condition capable of repair.

19. A method according to any of claims 12 to 17, wherein the subgroup of vehicle images all show a specific vehicle part in a damaged condition suitable for replacement.

20. A computational model for estimating vehicle damage repair produced by a method according to any of claims 12 to 19.

21. A computational model according to claim 20 adapted to compute a repair cost estimate by:
identifying from an image one or more damaged parts;
identifying whether the damaged part is capable of repair or suitable for replacement; and
calculating a repair cost estimate for the vehicle damage.

22. A computational model according to claim 21 further adapted to compute a certainty of the repair cost estimate.

23. A computational model according to claim 21 or 22 further adapted to determine a write-off recommendation.

24. A computational model according to any of claims 21 to 23 further adapted to compute its output conditional on a plurality of images of a damaged vehicle for estimating vehicle damage repair.

25. A computational model according to any of claims 21 to 24 further adapted to compute an estimate for internal damage.

26. A computational model according to any of claims 21 to 25 further adapted to request one or more further images from a user.

27. Software adapted to produce a computational model according to any of claims 20 to 26.

28. A processor adapted to produce a computational model according to any of claims 20 to 26.

29. A method of modelling data substantially as herein described and/or as illustrated with reference to the accompanying figures.

30. A method of producing a computational model for estimating vehicle damage repair substantially as herein described and/or as illustrated with reference to the accompanying figures.

31. A computational model substantially as herein described and/or as illustrated with reference to the accompanying figures.

32. Software for modelling data substantially as herein described and/or as illustrated with reference to the accompanying figures.

33. A system for modelling data substantially as herein described and/or as illustrated with reference to the accompanying figures.
